(19) United States
(12) Patent Application Publication
(10) Pub. No.: US 2011/0107005 A1
(43) Pub. Date: May 5, 2011

(54) SEMICONDUCTOR DEVICE

(75) Inventor: Yuji NAKAOKA, Tokyo (JP)

(73) Assignee: ELPIDA MEMORY, INC.

(21) Appl. No.: 12/910,428

(22) Filed: Oct. 22, 2010

(30) Foreign Application Priority Data
Oct. 29, 2009 (JP) 2009-248481

(51) Int. Cl. G06F 12/00

(52) U.S. Cl. 711/5; 711/106; 711/E12.001

(57) ABSTRACT

A renewal of an internal address generated by an internal address generator that is used for a refresh operation of information in a memory unit including a plurality of memory cells is preformed during a refresh operation before an activated word line connected to the memory cell corresponding to the internal address is inactivated in the refresh operation.

This application is based upon and claims the benefit of priority from Japanese patent application No. 2009-248481, filed on Oct. 29, 2009, the disclosure of which is incorporated herein in its entirety by reference.

### BACKGROUND

The present invention relates to a semiconductor device, and more particularly to a semiconductor memory device that needs to perform a refresh operation.

Semiconductor devices such as dynamic random access memories (DRAMs) have characteristics of losing stored data with the lapse of time. Therefore, this type of semiconductor devices needs to perform a rewriting operation (refresh operation) of stored data in order to maintain the stored data.

An enormous amount of time is required to refresh all memories in one refresh operation. Therefore, only part of memory cells is refreshed in one refresh operation.

A first example of related semiconductor devices has an address counter for sequentially designating addresses of groups of memory cells to be refreshed. This address counter is configured to be renewed (with increment) each time a refresh operation is completed. See, e.g., JP-A 05-182460, JP-A 2000-113668, and JP-A 2008-165865 (corresponding to US2008/0159041A1.)

Furthermore, a second example of related semiconductor devices has address counters provided for each group of memory cells, which is called a bank. While a reading or writing operation is performed on a selected bank, a refresh operation is performed on non-selected banks. See, e.g., JP-A 2001-332084 (corresponding to US2001/0043499A1.) The address counters of this semiconductor device are configured to be renewed each time a refresh request signal is inputted.

### SUMMARY

A semiconductor device shifts from an idle state to a variety of operating states. After a refresh operation has been completed, a semiconductor device returns to an idle state and then shifts to the next operating state in accordance with a command or the like.

In the first example of the related semiconductor device, after a refresh operation is completed (i.e., after a word line relating to the refresh operation is inactivated, the address counter for generating a refresh address is renewed in order to generate a refresh address necessary for the next refresh operation. Therefore, the semiconductor device cannot return to an idle state unless the address counter is renewed after the refresh operation has been completed. In other words, the semiconductor device cannot respond to a command or the like immediately after a refresh operation is completed. Thus, high-speed operation is inhibited.

In the second example of the related semiconductor device, after a refresh request signal is inputted, the address counter for generating a refresh address is renewed in order to generate a refresh address for designating a word line to be activated in response to the refresh request signal. Therefore, a long period of time is required for a refresh operation.

The present invention seeks to solve one or more of the above problems, or to improve upon those problems at least in part.

In one embodiment, a renewal of an internal address generated by an internal address generator that is used for a refresh operation of information in a memory unit including a plurality of memory cells is preformed during a refresh operation before an activated word line connected to the memory cell corresponding to the internal address is inactivated in the refresh operation.

### BRIEF DESCRIPTION OF THE DRAWINGS

The above features and advantages of the present invention will be more apparent from the following description of certain preferred embodiments taken in conjunction with the accompanying drawings, in which

FIG. 1 is a block diagram showing a general configuration of a semiconductor device according to a first exemplary embodiment of the present invention.

FIG. 2 is a block diagram showing details around a row address buffer and a refresh counter of the semiconductor device shown in FIG. 1.

FIG. 3 is a diagram explanatory of an arrangement example of four memory cell arrays included in the semiconductor device of FIG. 1.

FIG. 4 is a diagram showing a configuration example of the memory cell array included in the semiconductor device of FIG. 1.

FIG. 5 is a diagram showing circuitry of memory blocks other than memory blocks located on opposite ends of the memory cell array of FIG. 4.

FIG. 6 is a diagram showing circuitry of the memory blocks located on the opposite ends of the memory cell array of FIG. 4.

FIG. 7 is a circuit diagram of one of memory cells included in the memory blocks of FIGS. 5 and 6.

FIG. 8 is a circuit diagram of one of sense amplifiers included in the memory blocks of FIGS. 5 and 6.

FIG. 9 is a circuit diagram of a block decoder for outputting a selection signal to the memory cell array of FIG. 4.

FIG. 10 is a diagram explanatory of the relationship of input/output signals of the block decoder shown in FIG. 9.

FIG. 11 is a block diagram showing an internal configuration of a second control circuit part.

FIG. 12 is a timing chart of generation and extinction of signals generated in the second control circuit part of FIG. 11.

FIG. 13 is a timing chart showing variations of potentials of word lines and bit lines during a refresh operation.

FIG. 14 is a block diagram showing a detailed example of an internal address generator and block address latch circuits.

FIG. 15 is a block diagram showing another detailed example of an internal address generator and block address latch circuits.

FIG. 16 is a state transition diagram of the semiconductor device shown in FIG. 1.

FIG. 17 is a flow chart explanatory of a state transition between an idle state and an automatic refresh mode in the state transition of FIG. 16.

FIG. 18 is a signal waveform chart at respective parts of the semiconductor device shown in FIG. 1.

FIG. 19 is a diagram explanatory of an example of the order of the blocks to be refreshed.

FIG. 20 is a diagram explanatory of another example of the order of the blocks to be refreshed.

FIG. 21 is a block diagram showing a configuration of a data processing system including the semiconductor device of FIG. 1.

### DESCRIPTION OF EXEMPLARY EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

The present invention are based on a technical concepts that a renewal of an internal address of an internal address generator, which generates an internal address used for a refresh operation of a memory unit, to an address necessary for the next refresh operation is performed during a refresh operation (before an activated word line relating to the refresh operation is inactivated). A semiconductor device for achieving this goal includes a memory unit that needs to refresh, an internal address generator operable to generate an internal address used for a refresh operation of the memory unit, and a control circuit operable to control the refresh operation of the memory unit in accordance with a refresh request signal and to command the internal address generator to renew during the refresh operation.

Exemplary embodiments of the present invention will be described in detail below with reference to the accompanying drawings.

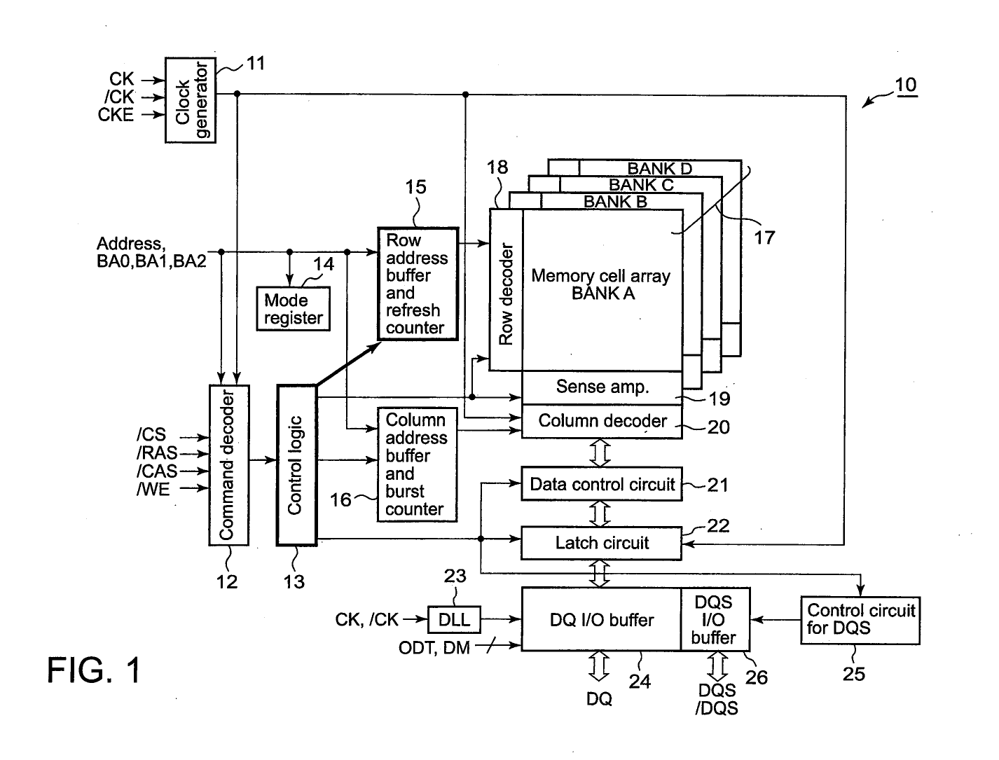

FIG. 1 is a block diagram showing a general configuration of a semiconductor device 10 according to a first exemplary embodiment of the present invention. For example, the semiconductor device 10 is a dynamic random access memory (DRAM).

The semiconductor device 10 has a clock generator 11, a command decoder 12, a control circuit 13, a mode register 14, a row address buffer and refresh counter 15, a column address buffer and burst counter 16, memory cell arrays 17, row decoders (also known as X-decoders) 18, sense amplifiers 19, column decoders (also known as Y-decoders) 20, a data control circuit 21, a data latch circuit 22, a delay locked loop (DLL) 23, a data input/output (DQ I/O) buffer 24, a data strobe signal control circuit 25, and a data strobe signal input/output (DQS I/O) buffer 26. The memory cell arrays 17 include a plurality of memory banks (four memory banks BANK_A to BANK_D in this example). The memory cell arrays 17 constitute a memory unit along with the row decoders 18, the sense amplifiers 19, and the column decoders 20. The memory unit (the memory cell arrays 17) needs to perform a refresh operation of information at predetermined intervals.

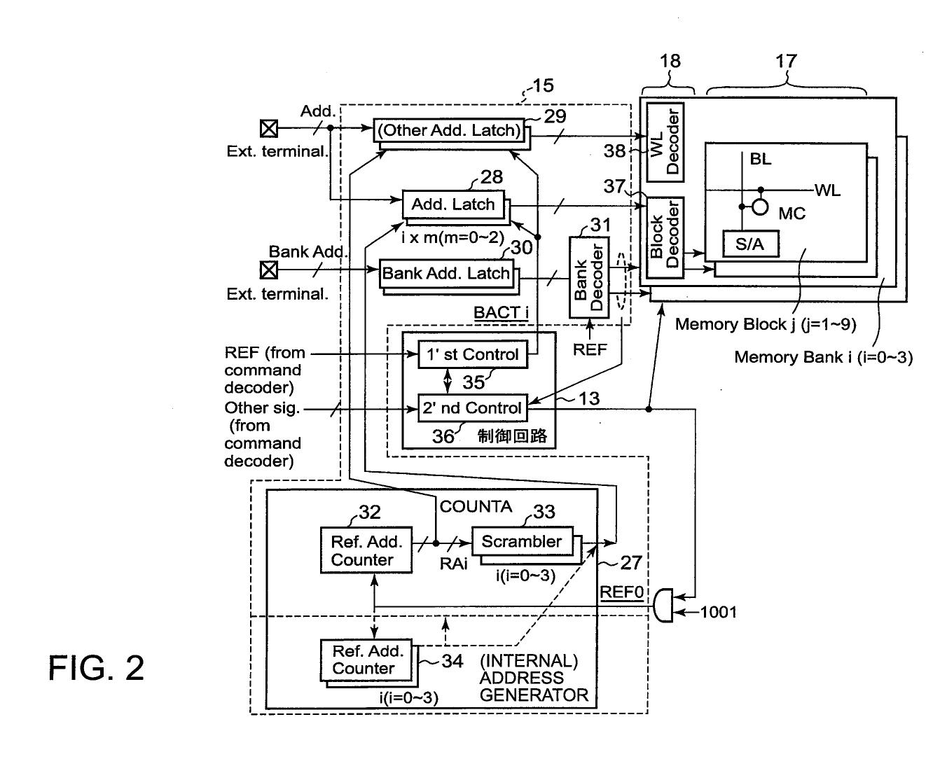

FIG. 2 is a block diagram showing details around the row address buffer and refresh counter 15 of the semiconductor device 10 shown in FIG. 1.

As shown in FIG. 2, the row address buffer and refresh counter 15 includes an internal address generator (IAG) 27, block address latch circuits 28, bank address latch circuits 30, other address latch circuits 29, and a bank decoder 31. The internal address generator 27 generates internal addresses for selecting a plurality of memory cells used for a refresh operation of the memory unit.

The internal address generator 27 generates internal addresses used when a refresh operation of the memory unit is performed.

The block address latch circuits 28, the bank address latch circuits 30, and the other address latch circuits 29 are provided so as to correspond to the memory banks BANK_A to BANK_D. The numbers of the block address latch circuits 28, the bank address latch circuits 30, and the other address latch circuits 29 are the same as the number of the memory banks. The memory banks are a plurality of storage areas accessible from an outside of the semiconductor device 10 with nonexclusive controls.

Each of the block address latch circuits 28 is arranged according to the number of bits to be latched. The bank address latch circuits 30 and the other address latch circuits 29 are configured in the same manner as the block address latch circuits 28. The plurality of block address latch circuits 28 is collectively referred to as an address holding circuit. In order to reduce a required area of the circuits, the other address latch circuits 29 may be integrated into one address latch circuit in common to all of the memory banks.

Under a normal operation, the bank decoder 31 selects one bank in accordance with information for designating a bank. For a refresh operation, the bank decoder 31 selects all of the banks in accordance with a refresh command REF.

The internal address generator 27 includes a refresh address counter 32 formed of a binary counter of a clock synchronization type or the like. The internal address generator 27 also includes four scramblers 33 corresponding to the memory banks (BANK_A to BANK_D). The scramblers 33 output different block addresses as internal addresses based upon the counter value of the refresh address counter 32. Alternatively, four refresh address counters 34 may be provided so as to correspond to the banks (BANK_A to BANK_D) instead of the refresh address counter 32 and the four scramblers 33. The refresh address counters 34 have different initial values and output different block addresses as internal addresses.

The control circuit 13 includes a first control circuit part 35 and a second control circuit part 36. The first control circuit part 35 commands the block address latch circuits 28 and the other address latch circuits 29 to latch the input addresses in response to a refresh request signal REF. The bank address latch circuits 30 latch the bank addresses in response to a memory access signal, which will be described later in connection with the reference numeral 1006.

The control circuit 13 controls activation and inactivation of word lines corresponding to internal addresses for performing a refresh operation of the memory unit in response to the refresh request signal. The control circuit 13 also commands the internal address generator to renew the internal addresses to addresses necessary for the next refresh operation before activated word lines being refreshed are inactivated. The details of the control circuit 13 will be described later.

The second control circuit part 36 controls a refresh operation of the memory unit. For example, the second control circuit part 36 controls the word lines WL and the bit lines BL or the sense amplifiers 19. Furthermore, the second control circuit part 36 commands the internal address generator 27 to renew (to count up the refresh address counter(s) 32 or 34) during a refresh operation. The phrase “during a refresh operation” is used to describe a period from the time when the block address latch circuit 28 latches an internal address to the time when a word line connected to a memory cell MC is activated and then inactivated. Furthermore, the renewal command to the internal address generator 27 is transmitted so that the renewal is completed during the refresh operation.

The row decoder 18 includes a block (or mat) decoder 37 and a word line (WL) decoder 38.

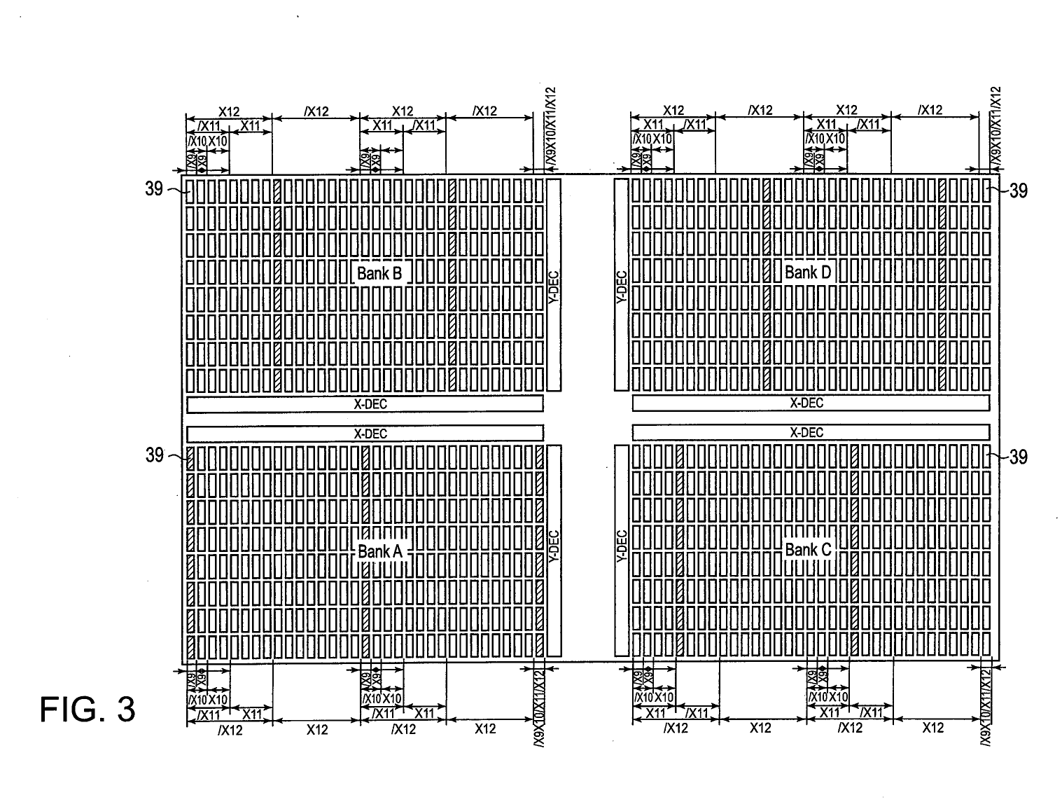

For example, the memory cell arrays 17 including the four memory banks (BANK_A to BANK_D), the row decoders 18, and the column decoders 20 are formed and arranged on the same circuit board as shown in FIG. 3.

Each of the four memory banks (BANK_A to BANK_D) of the memory cell arrays 17 includes a plurality of arrayed memory blocks (or memory mats) 39. Those memory blocks 39 include a plurality of arrayed memory cells. In the example of FIG. 3, each memory block 39 can be selected (activated) by a 4-bit block address, which is represented by X9 or /X9, X10 or /X10, X11 or /X11, and X12 or /X12.

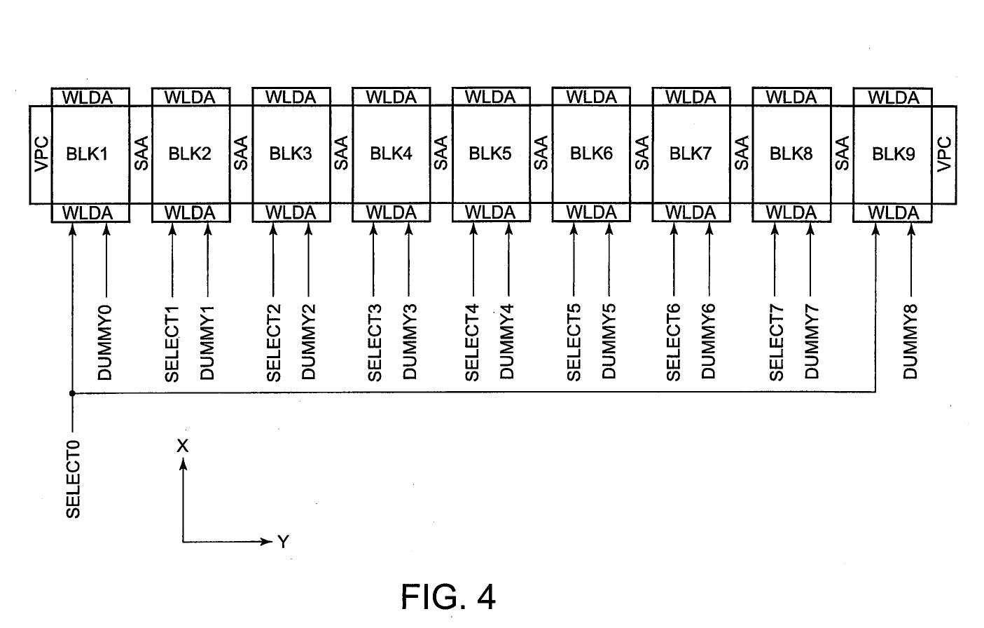

Each of the memory banks will be described in greater detail with reference to FIG. 4. Unlike FIG. 3, there will be described an example in which nine memory blocks BLK1 to BLK9 are arranged along the Y-direction. The present invention is not limited to a specific number of memory blocks arranged in a line.

As shown in FIG. 4, sense amplifier arrays SAA are arranged between adjacent memory blocks. Furthermore, word line driver arrays WLDA are arranged on both sides of each of the memory blocks BLK1 to BLK9 in the X-direction.

The memory blocks BLK1 to BLK9 are selected by corresponding selection signals SELECT0 to SELECT7. The memory blocks BLK1 and BLK9, which are located on opposite ends of the array, are selected (or accessed) by the same selection signal SELECT0. This is because the number of bit lines included in the memory blocks BLK1 and BLK9, which are located on the opposite ends of the array, is half of the number of bit lines included in the other memory blocks BLK2 to BLK8. A combination of the two memory blocks BLK1 and BLK9 is equivalent to one of the memory blocks BLK2 to BLK8.

Furthermore, dummy selection signals DUMMY0 to DUMMY8 are assigned to the memory blocks BLK1 to BLK9, respectively. The dummy selection signals DUMMY0 to DUMMY8 are signals for activating a dummy word line, which will be described later.

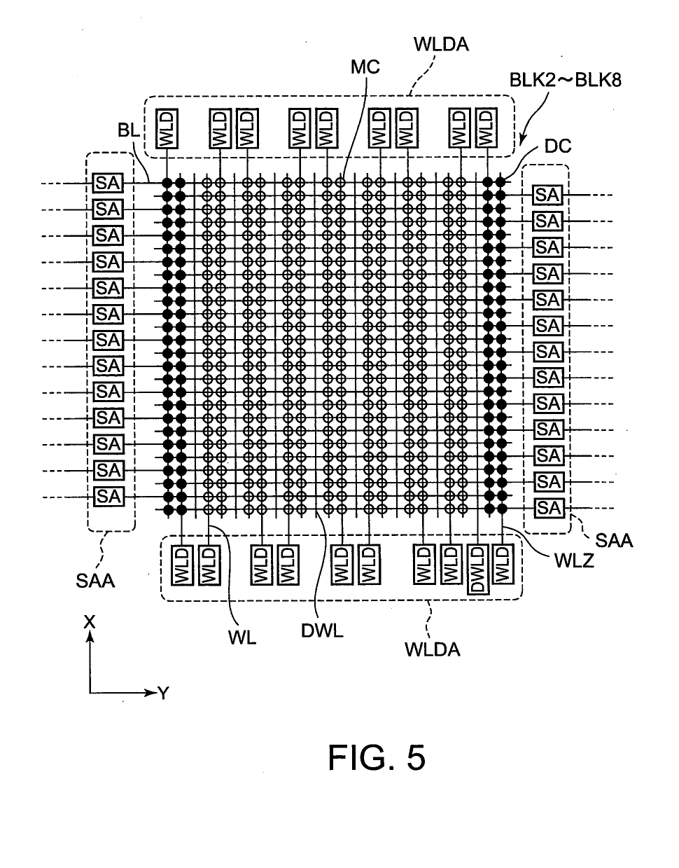

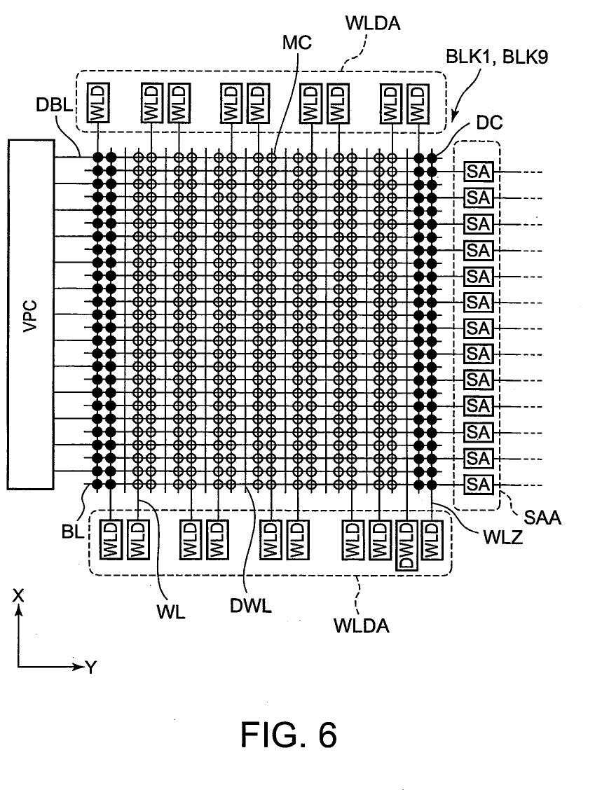

FIG. 5 is a diagram showing circuitry of the memory blocks BLK2 to BLK8 other than the memory blocks BLK1 and BLK9, which are located on the opposite ends of the array. FIG. 6 is a diagram showing circuitry of the memory blocks BLK1 and BLK9, which are located on the opposite ends of the array.

As shown in FIGS. 5 and 6, each of the memory blocks BLK1 to BLK9 includes a plurality of word lines WL extending along the X-direction, a plurality of bit lines BL extending along the Y-direction, and memory cells MC arranged at each intersection of the word lines WL and the bit lines BL. The numbers of the word lines WL and the bit lines BL in FIGS. 5 and 6 are only illustrated by way of example. The present invention is not limited to the illustrated example.

Half of the word lines WL are connected to a word line driver array WLDA disposed at one side of the memory block in the X-direction, and the other half of the word lines WL are connected to another word line driver array WLDA disposed at the other side of the memory block in the X-direction. Each of the word line driver arrays WLDA includes a plurality of word line drivers WLD for operating the corresponding word lines WL.

Some of the word lines located at ends of the memory block in the Y-direction (two word lines at each end of the memory block in this embodiment) are not used. Those word lines are unused word lines WLZ. This is because the process conditions of manufacturing the memory block are slightly different between the ends of the memory block and a central area of the memory block. Therefore, defective cells are likely to be produced at the ends of the memory block. Accordingly, memory cells connected to the unused word lines WLZ are regarded as dummy cells DC. Since the unused word lines WLZ are fixed in an inactivated state, the dummy cells DC are never connected to the bit lines BL.

Furthermore, each of the memory blocks BLK1 to BLK9 includes dummy word lines DWL extending along the X-direction. The dummy word lines DWL are provided for every two word lines WL. In other words, two word lines WL and one dummy word line DWL form a unit component. Such unit components are disposed repeatedly in the Y-direction. As shown in FIGS. 5 and 6, one of the dummy word lines DWL is connected to a dummy word line driver DWLD included in the dummy word line driver DWLD. The dummy word line driver DWLD is a circuit for activating the dummy word line DWL in response to the corresponding dummy selection signal DUMMY0 to DUMMY8. Any of the dummy word lines DWL may be connected to the dummy word line driver DWLD. Other dummy word lines DWL, which are not connected to the dummy word line driver DWLD, are fixed to a ground potential.

Neither memory cells MC nor dummy cells DC are located at intersections of the dummy word lines DWL and the bit lines BL. In other words, the dummy word lines DWL are dummy lines that do not contribute to actual operation by nature. Such dummy word lines DWL are provided because the semiconductor device adopts a layout in which an occupying area of the memory cells MC is 6F2 where F is the minimum processing dimension.

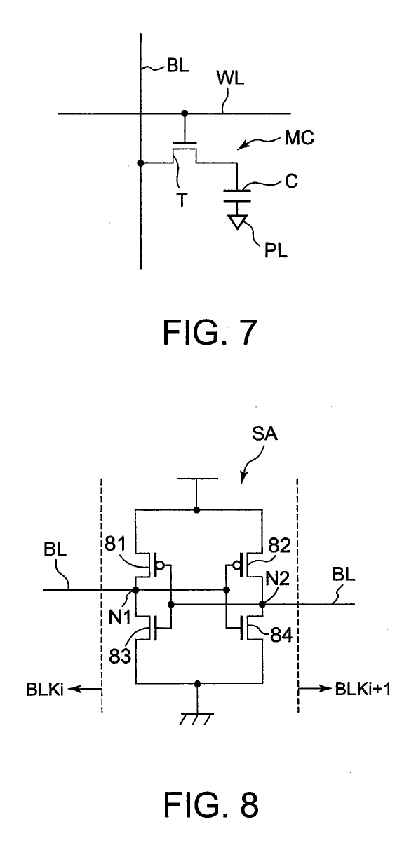

FIG. 7 is a circuit diagram of one of the memory cells MC included in the memory cell arrays 17. The memory cell MC needs to perform a refresh operation of information at predetermined intervals. As shown in FIG. 7, the memory cell MC has a cell transistor T and a cell capacitor C connected in series between the bit line BL and a plate line PL. The cell transistor T has a gate electrode connected to the corresponding word line WL. (Practically, the word line WL constitutes a gate electrode of the cell transistor T.) Thus, when the word line WL is activated, the cell capacitor C is electrically connected to the corresponding bit line BL. The cell transistor T has diffusion areas, one of which is connected to the bit line BL via a bit contact (not shown), and the other of which is connected to the cell capacitor C via a cell contact (not shown). The memory cells MC have been described as being located at intersections of the word lines WL and the bit lines BL with reference to FIGS. 5 and 6. However, the phrase “located at intersections” means that the memory cells MC are electrically connected to the corresponding word line WL and bit line BL as shown in FIG. 7 and does not refer to the physical relationship.

Referring back to FIG. 5, the bit lines BL in the memory blocks BLK2 to BLK8 are alternately connected to a sense amplifier array SAA arranged at a first side of the memory block in the Y-direction and to another sense amplifier array SAA arranged at a second side of the memory block in the Y-direction. Each of the sense amplifier arrays SAA includes a plurality of sense amplifiers SA. The sense amplifier array SAA located at the first side has input/output nodes connected to the bit lines BL of an adjacent memory block on the first side of the sense amplifier array SAA. The sense amplifier array SAA located at the second side has input/output nodes connected to the bit lines BL of an adjacent memory block on the second side of the sense amplifier array SAA. In other words, there is used an open bit line architecture (structure) in which, with regard to bit lines of one memory block, bit lines of another memory block are used as reference bit lines. The present invention is not limited to an open bit line architecture and may be applied to other systems such as a folded bit line architecture.

Meanwhile, as shown in FIG. 6, the bit lines BL and the dummy bit lines DBL are alternately arranged in the terminal memory blocks BLK1 and BLK9. The bit lines BL are connected to a sense amplifier array SAA arranged at one side of the memory block in the Y-direction. The dummy bit lines DBL are connected to a potential supply circuit VPC arranged at the other side of the memory block in the Y-direction. The potential supply circuit VPC is a circuit for supplying a precharge potential (VBLP) of the bit lines BL to the dummy bit lines DBL.

FIG. 8 is a circuit diagram of the sense amplifier SA. As shown in FIG. 8, the sense amplifier SA includes transistors 81-84 with flip-flop connection. The transistors 81 and 82 comprise a first conductive type of transistors, such as a P-channel MOS transistor. The transistors 83 and 84 comprise a second conductive type of transistors, such as an N-channel MOS transistor. A connection point between drains of the transistors 81 and 83 forms an input/output node N1. A connection point between drains of the transistors 82 and 84 forms another input/output node N2. The input/output node N1 is connected to the bit line BL of an adjacent memory block BLKj (j=1 to 8) on one side of the sense amplifier SA. The input/output node N1 is also connected to gates of the transistors 82 and 84. The input/output node N2 is connected to the bit line BL of an adjacent memory block BLKj+1 on the other side of the sense amplifier SA. The input/output node N2 is also connected to gates of the transistors 81 and 83.

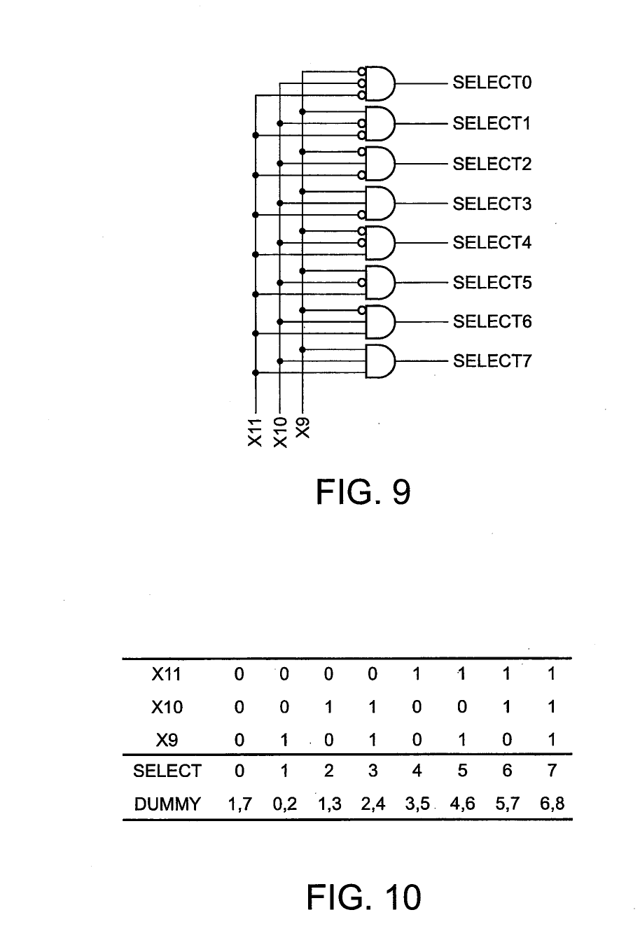

FIG. 9 is a circuit diagram of a block decoder (denoted by the reference numeral 37 in FIG. 1) for generating a selection signal SELECT0 to SELECT7.

As shown in FIG. 9, the block decoder includes eight AND gates with different combinations of inversion and non-inversion of input block address signals X9 to X11 (three bits in this example though four bits in FIG. 3). With this configuration, the block decoder decodes the block address signals X9 to X11, which are binary, and activates one of selection signals SELECT0 to SELECT7. FIG. 10 shows the relationship between the values of the block address signals X9 to X11 and the selection signals SELECT0 to SELECT7 to be activated.

Referring back to FIG. 2, the first control circuit part 35 of the control circuit 13 generates a bank activation signal BACTi (i=0 to 3) having a waveform of a one-shot pulse in accordance with a command from the command decoder (denoted by the reference numeral 12 in FIG. 1). The second control circuit part 36 controls the timing of generation of the bank activation signal. During a normal operation, the first control circuit part 35 activates a bank activation signal BACTi (i is one of 0 to 3) in accordance with information for designating a bank. During a refresh operation, the first control circuit part 35 activates all of bank activation signals BACTi (i is 0 to 3) based upon a refresh command REF. Furthermore, the first control circuit part 35 generates a refresh mode signal 1001, which defines a refresh cycle.

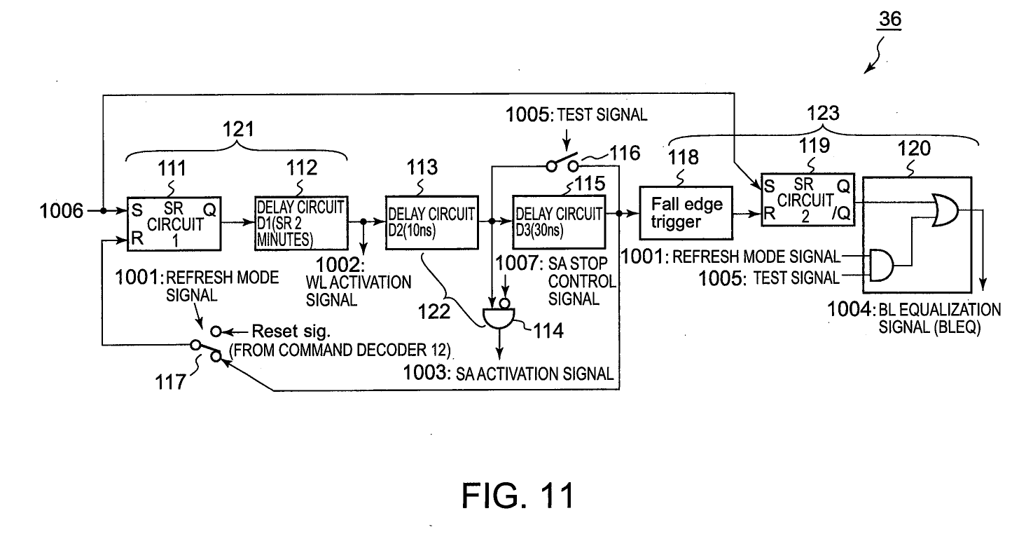

For example, the second control circuit part 36 is configured as shown in FIG. 11. The second control circuit part 36 of FIG. 11 includes a first set/reset (SR) circuit 111, a first delay circuit 112, a second delay circuit 113, a first gate circuit 114, a third delay circuit 115, a switch 116, a change-over switch 117, a fall edge trigger 118, a second SR circuit 119, and a second gate circuit 120.

The first SR circuit 111 and the first delay circuit 112 constitute a word line (WL) activation signal generation circuit 121 for generating a WL activation signal 1002. The second delay circuit 113 and the first gate circuit 114 constitute a sense amplifier (SA) activation signal generation circuit 122 for generating an SA activation signal 1003. The fall edge trigger 118, the second SR circuit 119, and the second gate circuit 120 constitute a bit line (BL) equalization control circuit 123 for generating a bit line equalization signal (BLEQ) 1004. The WL activation signal 1002, the SA activation signal 1003, and the bit line (BL) equalization signal 1004 are transmitted to the memory banks. Furthermore, the WL activation signal 1002 is also transmitted to the internal address generator 27.

The switch 116 is controlled by a test signal 1005, which is provided by the command decoder (denoted by the reference numeral 12 in FIG. 1), so as to disable (bypass) the third delay circuit 11.

An output of the third delay circuit 115 or the switch 116 is fed back to the first SR circuit 111 via the change-over switch 117. This feed back path forms an active time-out circuit.

For example, each of the first, second, and third delay circuits 112, 113, and 115 can be implemented by a combination of AND circuits and an even number of inverters.

When a memory cell access signal 1006 is inputted to the second control circuit part 36 of FIG. 11, the first and second SR circuits 111 and 119 are brought into a set state. At the time of a refresh operation, the memory cell access signal 1006 is provided by the first control circuit part 35. At the time of a writing or reading operation, the memory cell access signal 1006 is provided by the command decoder 12.

The first delay circuit 112 delays a Q output of the first SR circuit 111 and outputs the delayed signal as a WL activation signal 1002. The second delay circuit 113 delays the WL activation signal 1002 and outputs the delayed signal as an SA activation signal 1003. At the time of a test operation, however, the SA activation signal 1003 is not outputted because an SA stop control signal 1007 is inputted to the first gate circuit 114 from the command decoder 12.

During a normal refresh operation, an output of the third delay circuit 115 is supplied to a reset terminal of the first SR circuit 111 via the change-over switch 117 when a predetermined period of time (the delay time of the third delay circuit 115) has elapsed since the SA activation signal 1003 was outputted. Thus, the first SR circuit 111 is reset. At the time of a test operation, however, the switch 116 is turned on, so that the third delay circuit 115 is disabled (bypassed).

The change-over switch 117 is connected to a reset signal terminal (a terminal to which a reset signal is inputted from the command decoder 12) except in a refresh mode. As a result, the first SR circuit 111 is reset by an external command such as a precharge command.

The bit line equalization control circuit 123 inactivates the BL equalization signal 1004 when the memory cell access signal 1006 is inputted to the second SR circuit 119. Furthermore, the bit line equalization control circuit 123 activates the BL equalization signal 1004 when the fall edge trigger 118 detects a fall edge of the output of the third delay circuit 115. If both of the test signal 1005 and the refresh mode signal 1001 are inputted to the second gate circuit 120, the bit line equalization control circuit 123 activates the BL equalization signal 1004 irrespective of the state of the second SR circuit 119.

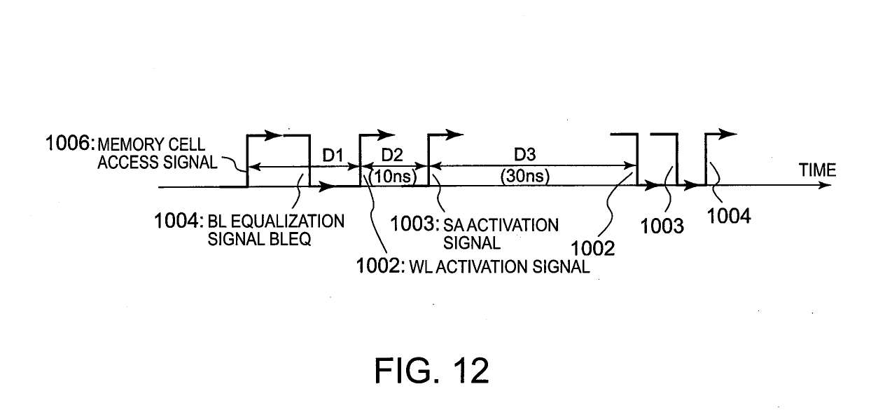

FIG. 12 shows the timing of generation and extinction of the WL activation signal 1002, the SA activation signal 1003, and the BL equalization signal 1004 outputted from the second control circuit part 36 of FIG. 11.

As shown in FIG. 12, when the memory cell access signal 1006 changes to a high level during a normal operation, the BL equalization signal 1004 changes into a low level. Furthermore, when delay time D1 has elapsed since the memory cell access signal 1006 changed to the high level, the WL activation signal 1002 changes into a high level. When delay time D2 has elapsed since then, the SA activation signal 1003 changes into a high level. When delay time D3 (e.g., 30 ns) of the third delay circuit 115 has elapsed since then, the WL activation signal 1002 and the SA activation signal 1003 sequentially change into a low level. Subsequently, the BL equalization signal 1004 changes into a high level. The set value of the delay time D3 is determined by a period of time required to re-inject (restore) charges into the memory cell from the sense amplifier.

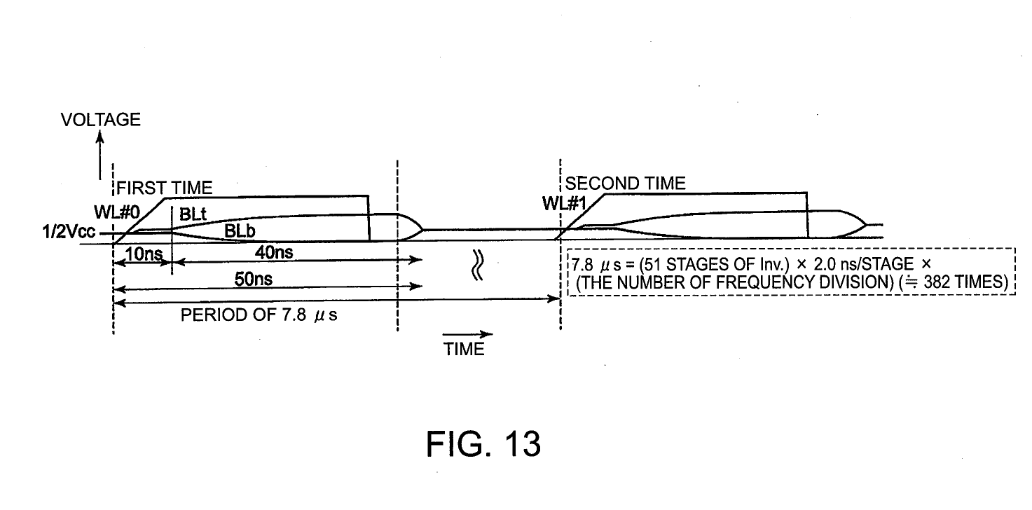

FIG. 13 is a timing chart of a normal refresh operation. The refresh cycle of a DRAM during a normal operation is determined as 7.8 μs by the data sheet specification. When a word line (WL) is activated, a potential difference is produced between a pair of bit lines (BLt and BLb) depending upon the stored contents of the memory cells. When a sense amplifier is activated, the potential difference produced between the pair of the bit lines is amplified so that one of the bit lines is brought into a high level and the other bit line is brought into a low level. Then the word line (WL) is inactivated, and the sense amplifier is inactivated. The bit lines are equalized (for example, into VCC/2) depending upon the bit line equalization signal.

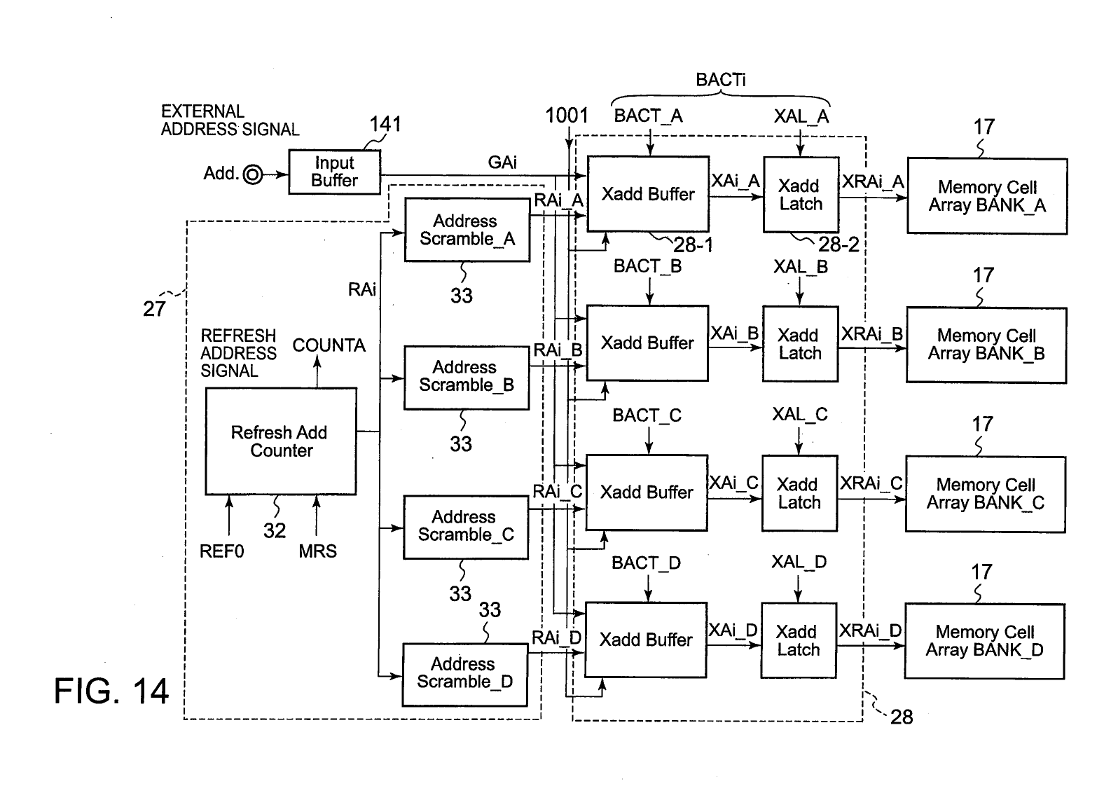

FIG. 14 is a block diagram showing the detail of the internal address generator 27 and the block address latch circuits 28. The refresh address counter 32 is initialized by a mode register set signal MRS. The refresh address counter 32 starts to count up with a counter initialization signal REF0. The refresh address counter 32 outputs a block address RAi to the scramblers 33 and outputs other word line addresses COUNTA to the other address latch circuits 29.

Each of the block address latch circuits 28 includes a buffer part 28-1 and a latch part 28-2. The buffer part 28-1 and the latch part 28-2 are activated by a bank activation signal BACTi (BACT_A to BACT_D and XAL_A to XAL_D). Furthermore, when the refresh mode signal 1001 is inputted, the buffer part 28-1 holds the block address from the scrambler 33. In other cases, the buffer part 28-1 holds an external address GAi held by an input buffer 141. The latch part 28-2 latches the block address or the external address held by the buffer part 28-1.

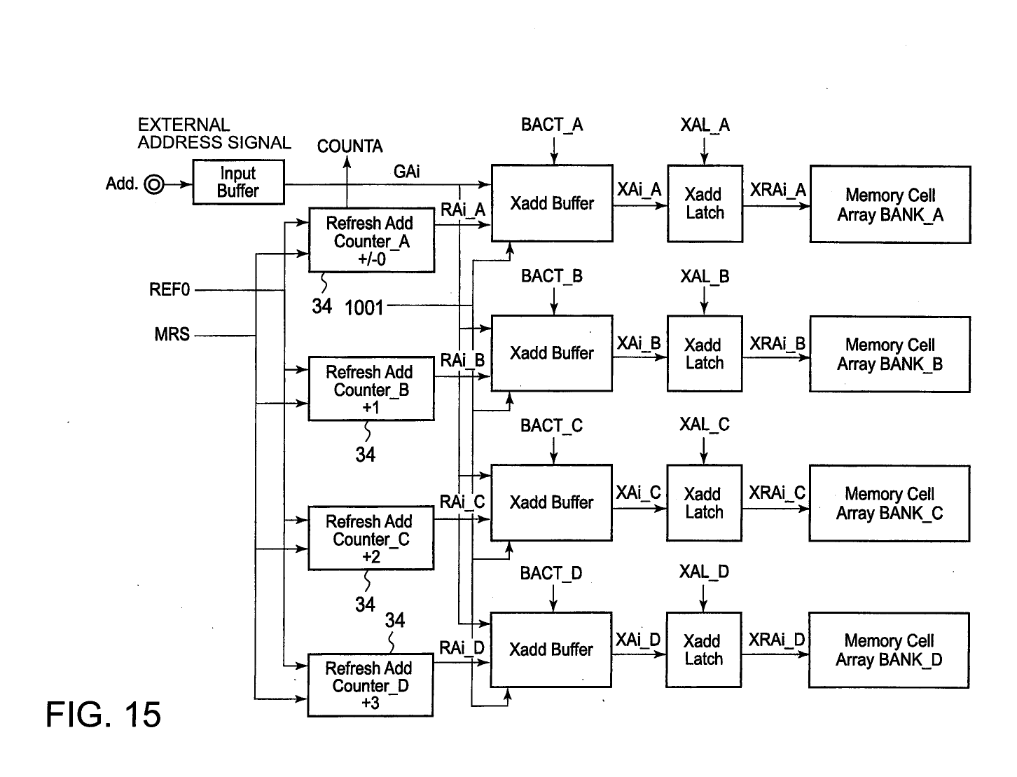

In a case where the internal address generator 27 includes a plurality of refresh address counters 34, the internal address generator 27 and the block address latch circuits 28 are arranged as shown in FIG. 15. The refresh address counters 34 have different initial values (±0, +1, +2, and +3). As with the refresh address counter 32, each of the refresh address counters 34 is initialized by a mode register set signal MRS. Each of the refresh address counters 34 starts to count up with a counter initialization signal REF0. The block address latch circuits 28 are the same as those shown in FIG. 14.

Operation of the semiconductor device 10 according to the present embodiment will be described below.

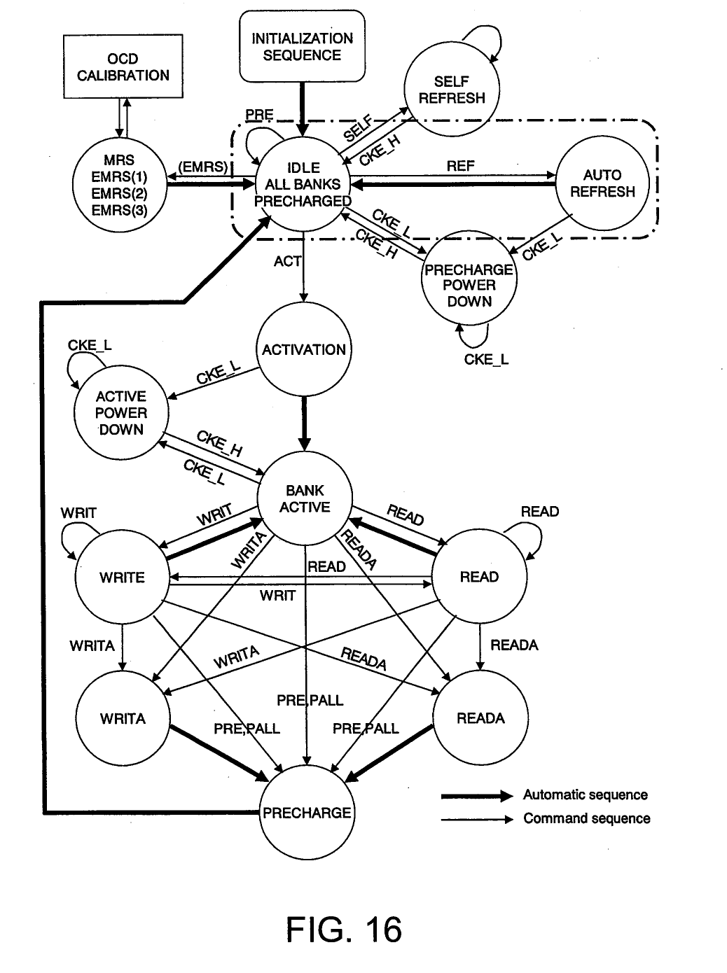

FIG. 16 is a state transition diagram of the semiconductor device 10. When power is turned on, the semiconductor device 10 changes into an idle state through an initialization sequence. Subsequently, with control by a variety of commands or the like, the semiconductor device 10 can change into various modes including a self refresh mode (SELF REFRESH), an automatic refresh mode (AUTO REFRESH), a precharge power down mode (PRECHARGE POWER DOWN), a mode register set mode (MRS), an activation mode (ACTIVATION), an active power down mode (ACTIVE POWER DOWN), a bank active mode (BANK ACTIVE), a writing mode (WRITE), a reading mode (READ), a writing mode with automatic precharge (WRITEA), a reading mode with automatic precharge (READA), and a precharge mode (PRECHARGE). The following description is focused on the transition between the idle state and the automatic refresh mode, which is a characteristic operation of the semiconductor device 10 and is illustrated by an alternate long and short dash line. Nevertheless, the present invention is not limited to an automatic refresh mode and is also applicable to a self refresh mode. In the case of a self refresh mode, the semiconductor device 10 can be operated in the similar manner by automatically generating a refresh request with an internal oscillator in accordance with a self refresh command. In the case of a self refresh mode, a refresh request signal REF is generated at predetermined intervals by an internal timer (not shown) in the semiconductor device 10. In the case of an automatic refresh mode, a refresh request signal REF is generated for each automatic refresh command.

As described above, when power is turned on, the semiconductor device 10 changes into an idle state through an initialization sequence. The initialization sequence includes precharging certain nodes of the device (including bit lines) into a predetermined potential. When a refresh command REF is inputted to the idling semiconductor device 10, a refresh operation is performed with use of the internal address generator 27. At that time, a necessary precharge operation is also performed. Then the semiconductor device 10 returns to an idle state.

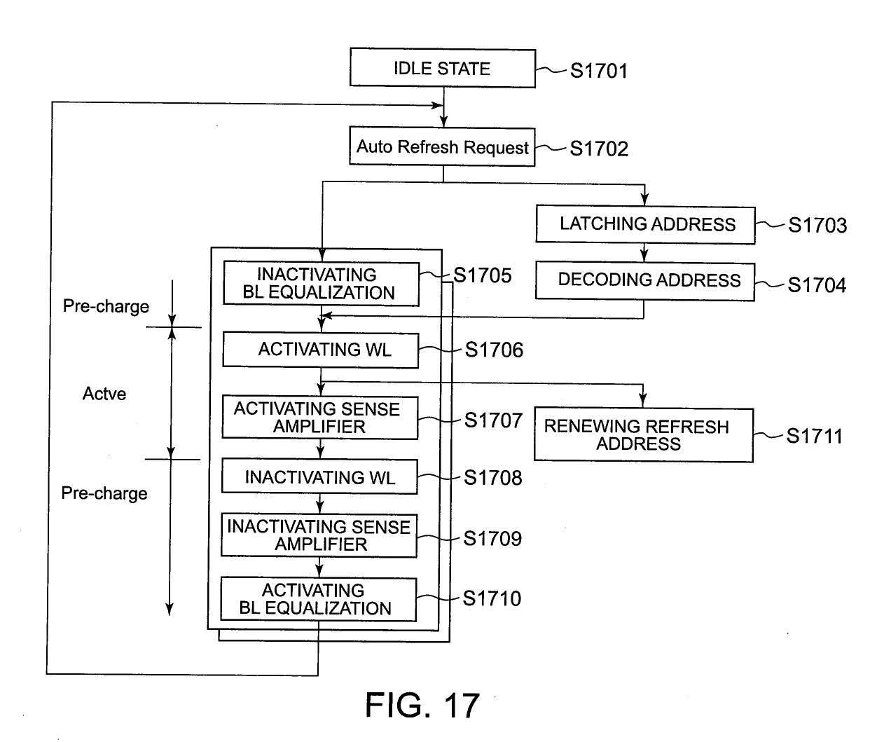

The transition of the semiconductor device 10 between the idle state and the automatic refresh mode, which is illustrated by an alternate long and short dash line of FIG. 16, will be described in greater detail with reference to FIG. 17.

The semiconductor device 10 is in an idle state (Step S1701). When the semiconductor device 10 receives an automatic refresh request (Step S1702), it latches an internal address generated by the internal address generator 27 (Step S1703) and decodes the latched address (Step S1704). Furthermore, the semiconductor device 10 inactivates bit line equalization (Step S1705).

Next, the semiconductor device 10 activates a word line (Step S1706) and activates a sense amplifier (Step S1707). Thus, a refresh operation is performed on memory cells to be refreshed. Subsequently, the semiconductor device 10 inactivates the word line (Step S1708) and inactivates the sense amplifier (Step S1709). Finally, the semiconductor device 10 activates bit line equalization (Step S1710) and returns to an idle state.

Furthermore, the semiconductor device 10 renews the refresh address counter 32 after it has latched the internal address (S1703) before it inactivates the word line (S1708). In the example of FIG. 17, the refresh address counter 32 is renewed after the word line has been activated (S1706).

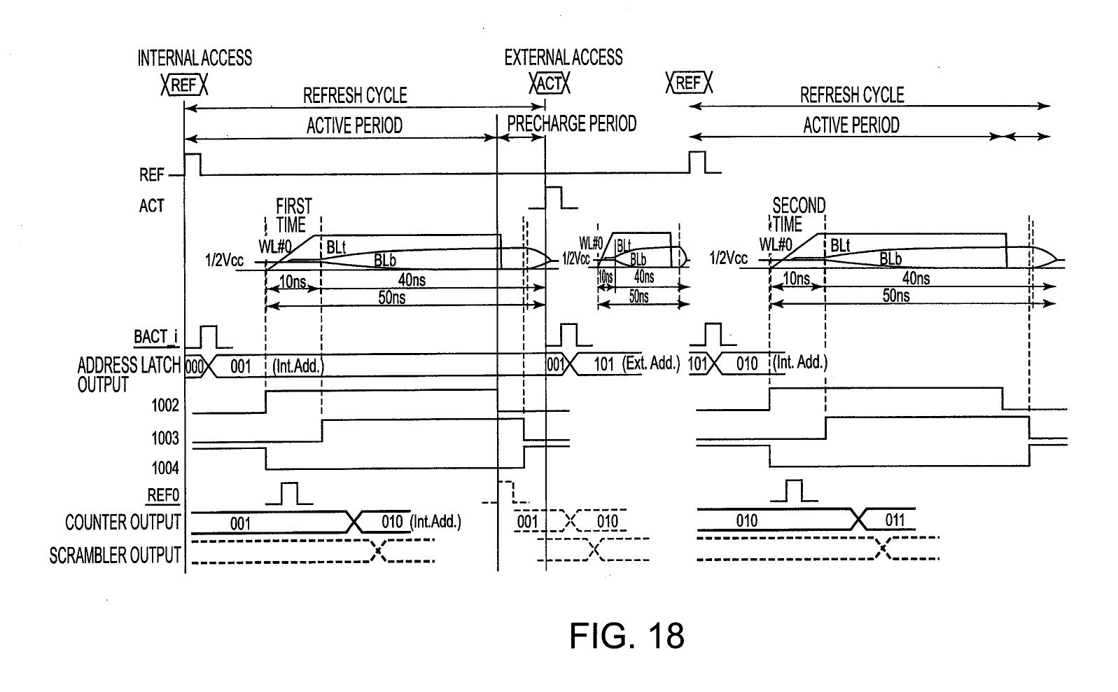

FIG. 18 is a signal waveform chart at respective parts of the semiconductor device 10. FIG. 18 shows that an internal access operation (automatic refresh), an external access operation (writing or reading), and an internal access operation (automatic refresh) are sequentially performed.

When the first control circuit part 35 receives an input notification of a refresh command REF from the command decoder 12, it generates bank activation signals BACTi for activating all of the banks.

The block address latch circuits 28 latch the address signals from the scramblers 33 in accordance with the bank activation signals BACTi. The other address latch circuits 29 also latch the address signals from the refresh address counter 32 in accordance with the bank activation signals BACTi. In FIG. 18, it is assumed that an output of the refresh address counter 32 is “001” and that an output of the scrambler 33 is “001.” Therefore, the block address latch circuit 28 latches “001.”

Thereafter, the WL activation signal 1002 is activated, and the BL equalization signal 1004 is inactivated. Thus, the potential of the word line is increased, so that a potential difference is produced between a pair of bit lines (BLt and BLb) depending upon the stored contents of the memory cells. Then the SA activation signal 1003 is activated so as to amplify the potential difference between the pair of bit lines.

Meanwhile, a counter renew signal REF0 is generated in accordance with the WL activation signal 1002 and supplied to the refresh address counter 32. The refresh address counter 32 is renewed (with increment) in accordance with the counter renew signal REF0. Thus, the output of the refresh address counter 32 becomes “010.” The renewal of the refresh address counter 32 is configured to be completed before the WL activation signal 1002 is inactivated. According to the related semiconductor device, the refresh address counter 32 is renewed after the WL activation signal 1002 has been inactivated as illustrated by the dashed line. Therefore, the related semiconductor device cannot deal with the next activation (ACT) command.

When the WL activation signal 1002 is then inactivated, the word line is inactivated. Furthermore, the SA activation signal 1003 is inactivated, and the BL equalization signal 1004 is activated so as to equalize the pair of bit lines.

In the present exemplary embodiment, the renewal of the refresh address counter 32 is completed before the beginning of the precharge period. Therefore, it is possible to deal with external access (ACT command) immediately after completion of the precharge period.

With regard to internal access for the second time, a refresh operation is performed in the same manner as described above. In FIG. 18, it is assumed that an output of the refresh address counter 32 is “010” and that an output of the scrambler 33 is “010.” Therefore, the block address latch circuit 28 latches “010.” In other words, a refresh operation is performed on the block address “010.”

Specifically, the semiconductor device 10 is configured as follows. The first control circuit part allows the address holding circuit to hold the internal address. Then the second control circuit part activates the word line corresponding to the internal address. The second control circuit part commands the internal address generator to renew the internal address into an internal address necessary for the next refresh operation so that the renewal is completed before the word line is inactivated.

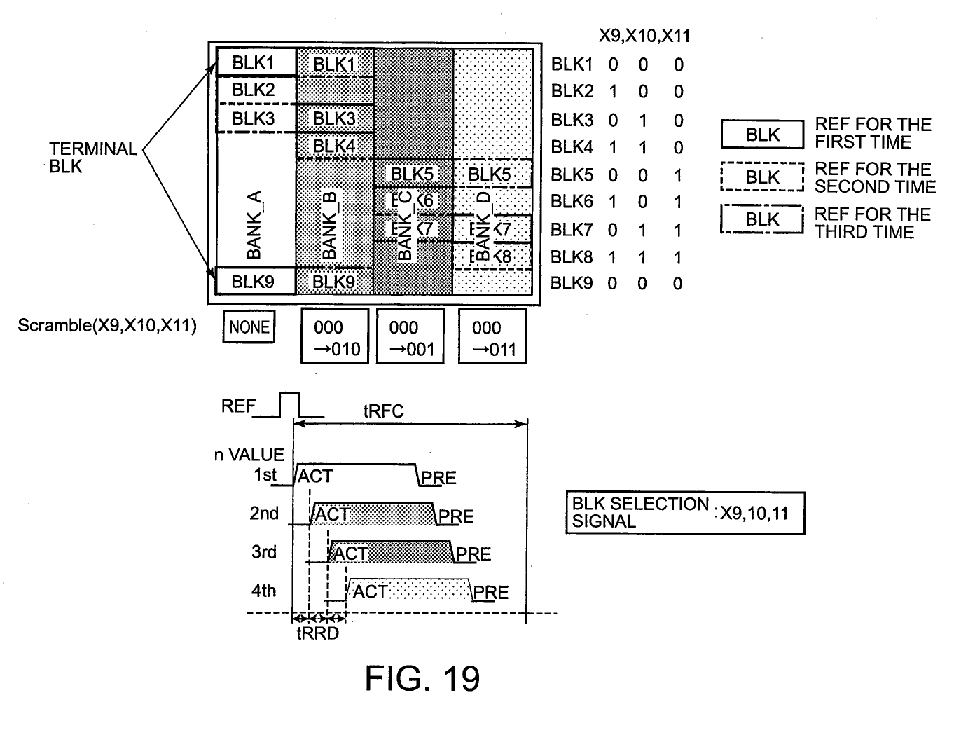

FIG. 19 shows an example of the order of the blocks to be refreshed in each of the banks. This example can be realized when the internal address generator 27 includes the scramblers 33.

Referring to FIG. 19, in the bank A, a refresh operation for the first time is performed on the blocks BLK1 and BLK9. Refresh operations for the second time and the third time are performed on the blocks BLK2 and BLK3, respectively. Meanwhile, in the bank B, refresh operations for the first time and the second time are performed on the blocks BLK3 and BLK4, respectively. A refresh operation for the third time is performed on the blocks BLK1 and BLK9. Furthermore, in the bank C, refresh operations for the first time, the second time, and the third time are performed on the blocks BLK5, BLK6, and BLK7, respectively. Moreover, in the bank D, refresh operations for the first time, the second time, and the third time are performed on the blocks BLK7, BLK8, and BLK5, respectively.

As shown at a lower part of FIG. 19, the timing of the refresh operations for the respective banks are shifted by delay time tRRD.

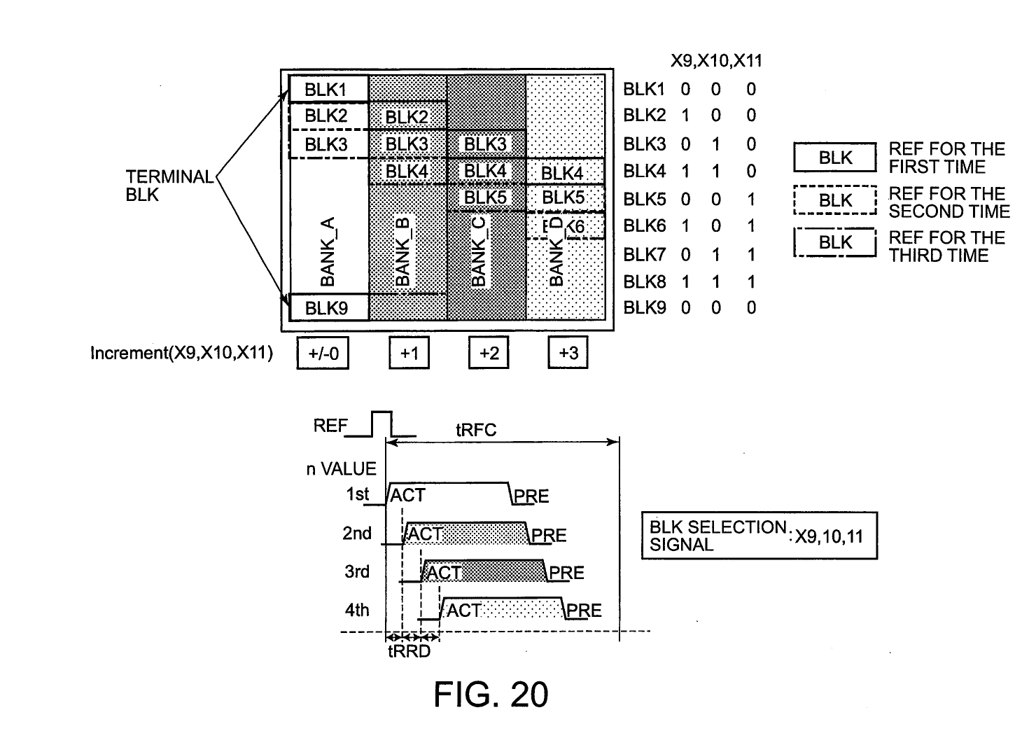

FIG. 20 shows another example of the order of the blocks to be refreshed in each of the banks. This example can be realized when the internal address generator 27 includes the refresh address counters 34.

Referring to FIG. 20, in the bank A, a refresh operation for the first time is performed on the blocks BLK1 and BLK9. Refresh operations for the second time and the third time are performed on the blocks BLK2 and BLK3, respectively. Furthermore, in the bank B, refresh operations for the first time, the second time, and the third time are performed on the blocks BLK2, BLK3, and BLK4, respectively. In the bank C, refresh operations for the first time, the second time, and the third time are performed on blocks BLK3, BLK4, and BLK5, respectively. In the bank D, refresh operations for the first time, the second time, and the third time are performed on blocks BLK4, BLK5, and BLK6. In this example, the timing of the refresh operations for the respective banks are also shifted by delay time tRRD.

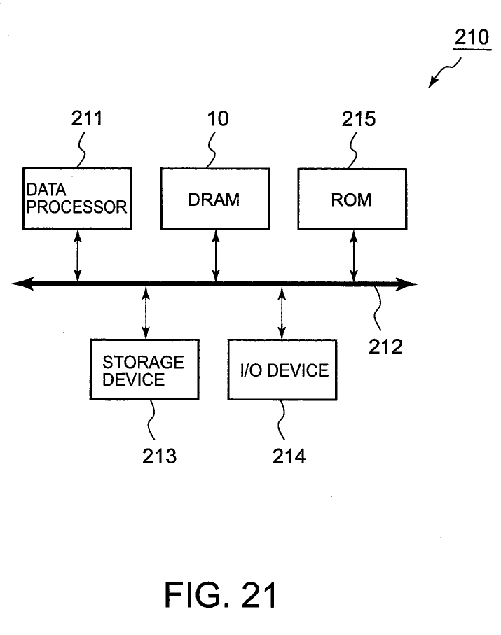

Next, a data processing system 210 using the semiconductor device 10 will be described with reference to FIG. 21.

The data (information) processing system 210 shown in FIG. 21 includes a data processor 211 and the semiconductor device (DRAM) 10, which are connected to each other via a system bus 212.

For example, the data processor 211 is a microprocessor (MPU) or a digital signal processor (DSP). Nevertheless, the present invention is not limited to those examples.

In FIG. 21, for the sake of brevity, the data processor 211 and the semiconductor device 10 are connected to each other via the system bus 212. Nevertheless, the data processor 211 and the semiconductor device 10 may be connected to each other via a local bus without the system bus 212.

Although FIG. 21 shows only one system bus 212 for the sake of brevity, system buses 212 may be provided in series or in parallel via a connector as needed.

Furthermore, in the data processing system 210 shown in FIG. 21, a storage device 213, an input/output (I/O) device 214, and a read only memory (ROM) 215 are connected to the system bus 212. Nevertheless, those components may be dispensed with.

Examples of the storage device 213 include a hard disk drive, an optical disk drive, and a flash memory. Examples of the I/O device 214 include a display device such as a liquid crystal display and an input device such as a keyboard and a mouse. Furthermore, the I/O device 214 may be provided with either one of an input device and an output device.

For the sake of brevity, each component is illustrated as a single element in FIG. 21. However, the present invention is not limited to this example, and a plurality of elements may be provided for one or more components of the components shown in FIG. 21.

In the data processing system of FIG. 21, the data processor 211 serves as a controller for controlling the semiconductor device 10.

The controller issues an interface chip of the semiconductor device 10 with commands relating to the refresh command and the active command. When the semiconductor device 10 receives the refresh command from the controller, it performs a refresh operation of stored information held in the semiconductor device 10. When the semiconductor device 10 receives the active command from the controller, it outputs corresponding stored information to the controller. The commands issued by the controller are known commands (system commands) for controlling a semiconductor device, which are defined by the industrial group.

In a semiconductor device according to an exemplary embodiment of the present invention, during a refresh operation (before an activated word line relating to the refresh operation is inactivated), an internal address generator is commanded to renew an internal address to an address necessary for the next refresh operation. Therefore, a period of time required for the semiconductor device to be ready to respond to the next command after the refresh operation can be shortened without extending a period of time required for the refresh operation.

Although the present invention has been described base upon some embodiments, the present invention is not limited to those embodiments. It should be understood that various changes and modifications may be made therein without departing from the spirit and scope of the present invention.

For example, the primary technical idea of the present invention is applicable not only to an automatic refresh operation, but also to an internal operation of a self refresh operation. Furthermore, the present invention is not limited to an open bit line structure.

Furthermore, the present invention is applicable to general semiconductor products having a DRAM function, such as a central processing unit (CPU), a micro controller unit (MCU), a digital signal processor (DSP), an application specific integrated circuit (ASIC), and an application specific standard product (ASSP).

Moreover, semiconductor devices to which the present invention has been applied are applicable to various kinds of technology, such as system-on-a-chip (SOC), multi-chip package (MCP), and package-on-package (POP). Furthermore, field effect transistors (FETs) or bipolar transistors may be used for the transistors. There may be used various types of FETs including a metal oxide semiconductor (MOS), a metal-insulator semiconductor (MIS), and a thin film transistor (TFT). Transistors other than FETs may also be used. A bipolar transistor may partially be included. Typical examples of the first conductive type of transistors include a P-channel transistor and a P-type MOS transistor. Typical examples of the second conductive type of transistors include an N-channel transistor and an N-type MOS transistor. Not only a p-type semiconductor substrate but also an N-type semiconductor substrate may be used as a semiconductor substrate. A semiconductor substrate having a silicon-on-insulator (SOI) structure or other semiconductor substrates may be used.

The circuit configuration of various circuits including the circuits for counters, the circuits for addresses, and the memory arrays is not limited to the circuit configuration illustrated in the above embodiments.

Furthermore, the refresh address counter(s) may be configured to count down.

The disclosed elements may be combined or selected in various ways within the scope of the appended claims of the present invention. In other words, the present invention includes various variations and modifications that would be apparent to those skilled in the art from the entire disclosure and technical concept including the appended claims.

What is claimed is:

1. A device, comprising:
a memory unit which includes a plurality of memory cells that need to refresh information at predetermined intervals;
an internal address generator which generates an internal address that selects the plurality of memory cells used in a refresh operation of the memory unit; and
a control circuit which controls activation and inactivation of a word line corresponding to the internal address that performs the refresh operation of the memory unit in accordance with a refresh request signal corresponding to the predetermined intervals and which commands the internal address generator to renew the internal address to an address necessary for a next refresh operation before an activated word line being refreshed is inactivated.

2. The device as recited in claim 1, wherein the memory unit includes a plurality of memory banks of nonexclusive controls with respect to each other,
each of the plurality of memory banks includes a plurality of memory blocks, and
the internal address generator generates, as the internal address, a plurality of block addresses that designates one of the plurality of memory blocks in each of the plurality of memory banks.

3. The device as recited in claim 2, wherein the internal address generator includes:
one address counter which generates a block address, and a plurality of scramblers which generate different block addresses corresponding to the plurality of memory banks from one block address that is a counter value of the address counter.

4. The device as recited in claim 2, wherein the internal address generator includes a plurality of address counters which generate different block addresses corresponding to the plurality of memory banks.

5. The device as recited in claim 1, further comprising an address holding circuit which holds the internal address,
wherein the control circuit includes;
a first control circuit part which allows the address holding circuit to hold the internal address in accordance with the refresh request signal, and
a second control circuit part which controls the word line included in the memory unit,
wherein the second control circuit part commands the internal address generator to renew the internal address to an address necessary for the next refresh operation so that the renewal is completed after the first control circuit part has allowed the address holding circuit to hold the internal address and a period between the second control circuit part activates the word line corresponding to the internal address and the second control circuit part inactivates the word line.

6. The device as recited in claim 5, wherein the second control circuit part commands the internal address generator to renew the internal address by using a word line activation signal that activates the word line.

7. The device as recited in claim 5, wherein the memory unit includes a plurality of memory banks,
each of the plurality of memory banks includes a plurality of memory blocks, and
the address holding circuit includes a plurality of latch circuits corresponding to the plurality of memory banks.

8. The device as recited in claim 7, wherein an external address is supplied to each of the plurality of latch circuits in addition to the block address that designates one of the plurality of memory blocks in each of the plurality of memory banks, and
each of the plurality of latch circuits selects one of the block address and the external address corresponding activity or inactivity of a refresh mode signal.

9. The device as recited in claim 1, wherein the memory unit includes a plurality of memory banks of nonexclusive controls with respect to each other,
each of the plurality of memory banks includes a plurality of memory blocks,
the memory unit has an open bit line structure in which the plurality of memory blocks is arranged in a line in each of the memory banks and in which a reading operation of the memory cell is performed with a sense amplifier so that, with regard to bit lines of one of two adjacent memory blocks, bit lines of the other memory block are used as reference bit lines, and
two of the plurality of memory blocks located on opposite ends are accessed simultaneously in accordance with the refresh request signal.

10. The device as recited in claim 3, wherein the memory unit includes a plurality of memory banks of nonexclusive controls with respect to each other,
each of the plurality of memory banks includes a plurality of memory blocks,
the memory unit has an open bit line structure in which the plurality of memory blocks is arranged in a line in each of the memory banks and in which a reading operation of the memory cell is performed with a sense amplifier so that, with regard to bit lines of one of two adjacent memory blocks, bit lines of the other memory block are used as reference bit lines, and
two of the plurality of memory blocks located on opposite ends are accessed simultaneously in accordance with the refresh request signal.

11. The device as recited in claim 4, wherein the memory unit includes a plurality of memory banks of nonexclusive controls with respect to each other,
each of the plurality of memory banks includes a plurality of memory blocks,
the memory unit has an open bit line structure in which the plurality of memory blocks is arranged in a line in each of the memory banks and in which a reading operation of the memory cell is performed with a sense amplifier so that, with regard to bit lines of one of two adjacent memory blocks, bit lines of the other memory block are used as reference bit lines, and
two of the plurality of memory blocks located on opposite ends are accessed simultaneously in accordance with the refresh request signal.

12. An information processing system, comprising:
a device including;
a memory unit which includes a plurality of memory cells that need to refresh information at predetermined intervals,
an internal address generator which generates an internal address that selects the plurality of memory cells used in a refresh operation of the memory unit, and
a control circuit which controls activation and inactivation of a word line corresponding to the internal address that performs the refresh operation of the memory unit in accordance with a refresh request signal corresponding to the predetermined intervals and which commands the internal address generator to renew the internal address to an address necessary for a next refresh operation until an activated word line being refreshed is inactivated;
a bus connected to the device; and
a controller connected to the bus.

13. The information processing system as recited in claim 12, wherein the memory unit includes a plurality of memory banks of nonexclusive controls with respect to each other,
each of the plurality of memory banks includes a plurality of memory blocks,
the internal address generator generates, as the internal address, a plurality of block addresses that designates one of the plurality of memory blocks in each of the plurality of memory banks, and
the internal address generator includes;
one address counter which generates a block address, and
a plurality of scramblers which generate different block addresses corresponding to the plurality of memory banks from one block address that is a counter value of the address counter.

14. The information processing system as recited in claim 12, wherein the memory unit includes a plurality of memory banks of nonexclusive controls with respect to each other,
each of the plurality of memory banks includes a plurality of memory blocks,
the internal address generator generates, as the internal address, a plurality of block addresses that designates one of the plurality of memory blocks in each of the plurality of memory banks, and
the internal address generator includes a plurality of address counters which generate different block addresses corresponding to the plurality of memory banks.

15. A method of refreshing a device, comprising:
renewing an internal address generated by an internal address generator that is used for a refresh operation of information in a memory unit including a plurality of memory cells during a refresh operation before an activated word line connected to the memory cell corresponding to the internal address is inactivated in the refresh operation.

16. The method as recited in claim 15, wherein the internal address generated by the internal address generator is held in accordance with a refresh request signal corresponding to predetermined intervals by an address holding circuit,
the refresh operation is performed for the memory unit by using the internal address held by the address holding circuit, and
the internal address generator is renewed so that the renewing to the internal address necessary for a next refresh operation is completed before the activated word line included in the refresh operation is inactivated.

17. The method as recited in claim 16, wherein the renewing of the internal address generator is started at the same time as activation of the word line.
